(19) United States
(12) Patent Application Publication
(10) Pub. No.: US 2009/0109186 A1
(43) Pub. Date: Apr. 30, 2009

(54) DISPLAY DEVICE

(75) Inventors: Hsuan-Lin PAN, Taipei County (TW); Po-Sheng SHIH, Taipei County (TW); Kei-Hsiung YANG, Taoyuan County (TW); Po-Yang CHEN, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HANNSTAR DISPLAY CORP., Tao-Yuan Hsien (TW)

(21) Appl. No.: 12/145,881

(22) Filed: Jun. 25, 2008

Related U.S. Application Data
(63) Continuation-in-part of application No. 11/927,701, filed on Oct. 30, 2007.

(30) Foreign Application Priority Data
Nov. 6, 2007 (TW) 096141813

(51) Int. Cl. G06F 3/041

(52) U.S. Cl. 345/173

(57) ABSTRACT

A display device is disclosed by the present invention and is constituted by a substrate, an inducing element, and a counter electrode. The substrate comprises a pixel electrode and a first conductive line. A counter substrate faces the substrate. The inducing element is disposed on the substrate and comprises a passivation layer, which is electrically connected to the first conductive line and is disconnected to the pixel electrode. The counter electrode is disposed between the substrate and the counter substrate, which is corresponding to the inducing element with a variable gap less or equal than 1 μm between the passivation layer and the counter electrode.

### CROSS REFERENCE TO RELATED APPLICATIONS

This application is a Continuation-In-Part of pending U.S. patent application Ser. No. 11/927,701, filed Oct. 30, 2007.

This Application claims priority of Taiwan Patent Application No. 096141813, filed on Nov. 6, 2007, the entirety of which is incorporated by reference herein.

### BACKGROUND OF THE INVENTION

1. Field of the Invention

The invention relates to a display device and more particularly relates to a touch input display device.

2. Description of the Related Art

Touch panel displays, such as cell phone panels, digital camera panels and display panels, are widely used in our daily life due to simple operation following the popularization of electronic devices.

FIG. 1 shows a plan view of a touch panel display device with inducing element. FIG. 2A shows a cross section along I-I′ of FIG. 1. Referring to FIG. 1, in addition to a switching element 102, the touch panel display device 100 further comprises an inducing element 104 in pixel layout. The switching element 102 electrically connects a gate line 106, a data line 108 crossing the gate line 106 and a pixel electrode 110. The inducing element 104 electrically connects another gate line 106 and is isolated (or disconnected) from the pixel electrode 110. In FIG. 2A, the inducing element 104 comprises a gate 206, a source electrode 214, a drain electrode 216, a channel 212 and a passivation layer 234. The passivation layer 234 of the inducing element 104 is separated from the counter electrode 218 corresponding the inducing element 104 by a distance (or gap) d₁, and current of the inducing element 104 depends upon voltages of the gate 206, the source electrode 214, and the drain electrode 216. Referring to FIG. 2B, which shows the touch input display device of FIG. 2A after touched, an external force 120 is applied to the touch input display device, the distance between the counter electrode 218 and the passivation layer 234 of the inducing element 104 is reduced from d₁ to d₂, meanwhile, current of the inducing element 104 depends upon voltages of the gate 206, the source electrode 214, the drain electrode 216, and the counter electrode 218. The smaller the distance d₂ is, current of the inducing element 104 is more affected by voltage of the counter electrode 218. That is, the more distance variation between the counter electrode 218 and the inducing element 104 occurs, the more inducing signal of the inducing element 104 produces.

However, the distance variation between the counter electrode and the inducing element is small usually with operating the touch input display device, thus the inducing element produces a small inducing signal which is disadvantageous to subsequent signal processing. Hence, the touch input display device is less sensitive and not good enough.

### BRIEF SUMMARY OF INVENTION

The invention provides a display device. The display device provides a substrate comprises a pixel electrode and a first conductive line. A counter substrate faces the substrate. An inducing element comprises a passivation layer disposed on the substrate, electrically connected to the first conductive line and isolated (or disconnected) from the pixel electrode. A counter electrode corresponds to the inducing element, interposed between the substrate and the counter substrate, wherein a variable gap d is between the passivation layer and the counter electrode, and d≦1 μm.

The invention provides a display device. The display device provides a counter substrate is opposite a substrate, wherein the substrate comprises a pixel electrode and a first conductive line. An inducing element comprises a passivation layer, electrically connected to the first conductive line and isolated from the pixel electrode. A counter electrode corresponds the inducing element. A protrusion element is interposed between the counter electrode and the counter substrate.

### BRIEF DESCRIPTION OF DRAWINGS

The invention can be more fully understood by reading the subsequent detailed description and examples with references made to the accompanying drawings, wherein:

FIG. 1 shows a plan view of a touch panel display device with a conventional inducing element.

FIG. 2A shows a cross section along I-I′ of FIG. 1.

FIG. 2B shows the touch input display device of FIG. 2A after touched by an external force.

FIG. 3 shows a chart with drain current as a function of a gap between an inducing element and a counter electrode according to a touch input display of the invention.

FIG. 4 and FIG. 5 illustrate the operation mechanism of reducing the gap between the inducing element and the counter electrode in accordance with an embodiment according to the invention.

FIG. 6 shows a touch input display device of an embodiment according to the invention.

FIG. 7 shows a touch input display device of another embodiment according to the invention.

FIG. 8 shows a touch input display device of further another embodiment according to the invention.

### DETAILED DESCRIPTION OF INVENTION

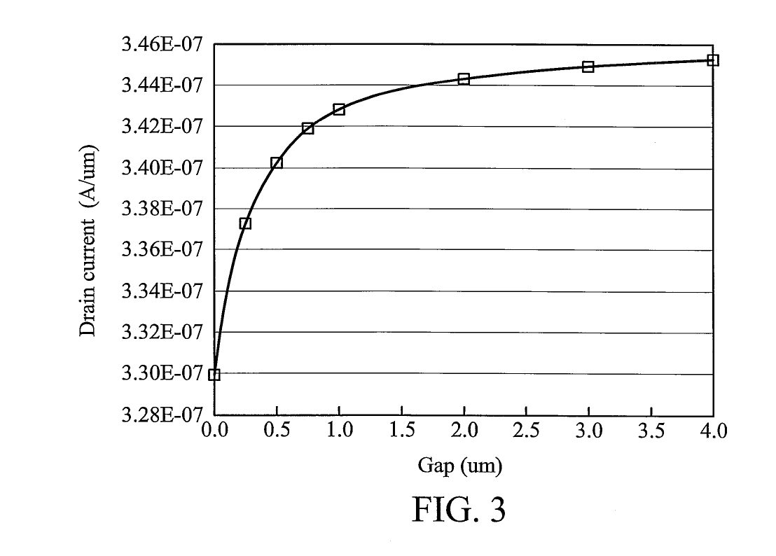

Referring to FIG. 3, which shows a chart with drain current as a function of a gap between an inducing element and a counter electrode according to a touch input display of the invention. When the gap between the inducing element and the counter electrode becomes smaller, the drain current is therefore reduced, and is more reduced when the gap is less than about 2 μm, and is even more significantly reduced when the gap is less than about 1 μm.

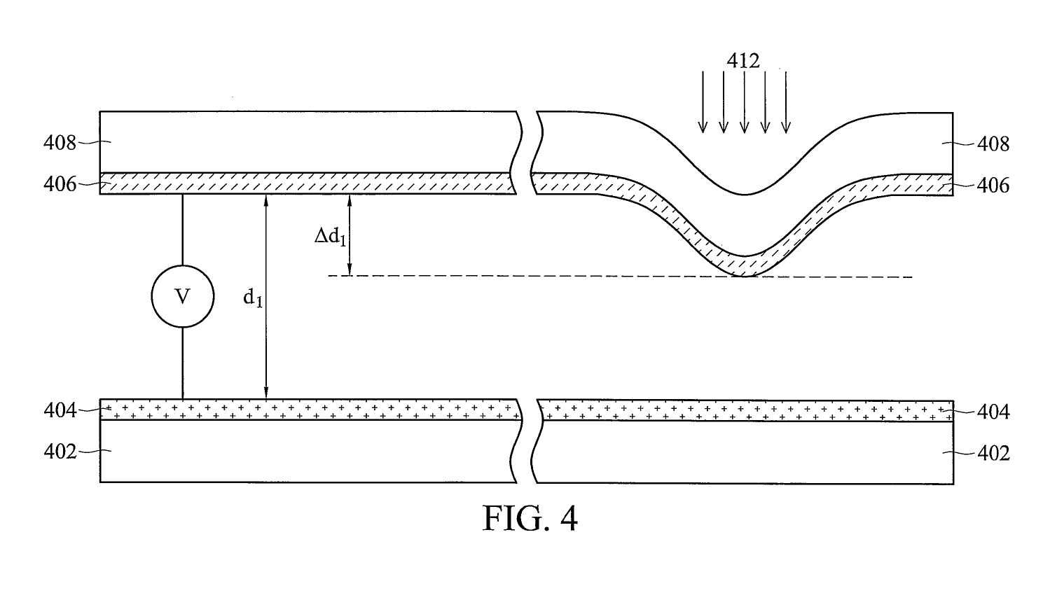

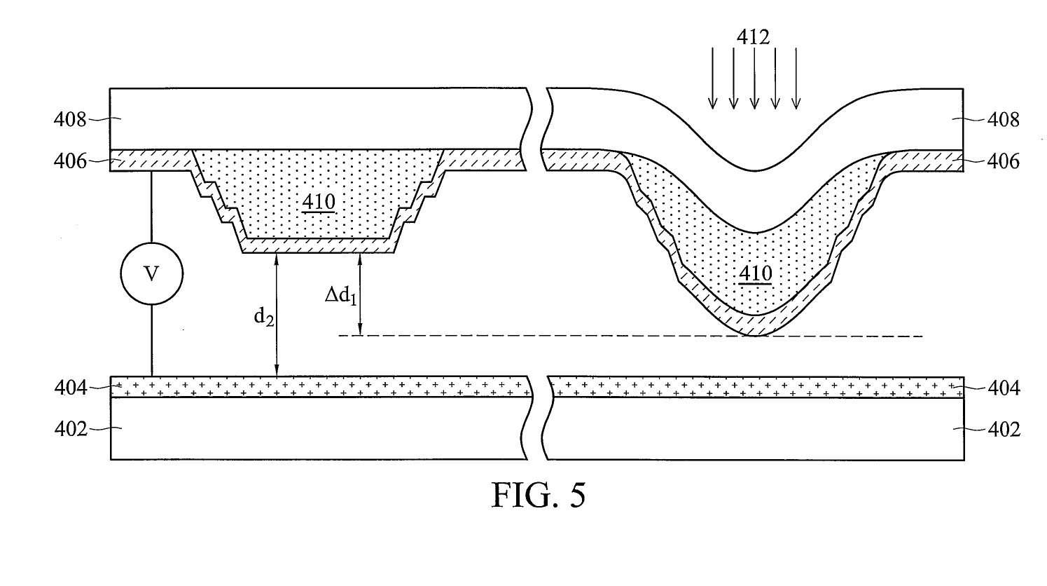

The following paragraph will illustrate the operation mechanism of reducing the gap between the inducing element and the counter electrode with FIG. 4 and FIG. 5 in accordance with an embodiment according to the invention. Referring to FIG. 4, a passivation layer 404 on an inducing element (not shown for simplicity) over a substrate 402 is separated from a counter electrode 406 on a counter substrate 408 by a gap d₁. The inducing element and the counter electrode 406 have the voltage difference V, the electric field applied to the inducing element is E₁, and V=E₁×d₁. When an external force 412 is applied to the counter substrate 408, the counter substrate 408 is deformed to generate a gap variation Δd₁ between the passivation layer 404 and the counter electrode 406, and an electrical field E₁′ applied to the inducing element therefore, and V=E₁′×(d₁−Δd₁). The smaller (d₁−Δd₁) is, the greater the electrical field E₁′ becomes, and the inducing element produces a greater inducing signal. Hence, the sensitivity of the touch input display device with respect to the external force 412 can be increased by decreasing the gap d₁. Referring to FIG. 5, which differs from FIG. 4 only by forming a protruding element 410 corresponding to the inducing element between the counter substrate 408 and the counter electrode 406, the present gap between the passivation layer 404 and the counter electrode 406 is d₂, and d₂=d₁−t<d₁. The electric field applied to the inducing element is E₂, and V=E₂×d₂. When the external force 412 is applied to the counter substrate 408, in which the gap variation between the passivation layer 404 and the counter electrode 406 is assumed to be Δd₁, the electric field applied to the inducing element is E₂′, and V=E₂′×(d₂−Δd₁). The equations below are therefore derived.

V=E₁′×(d₁−Δd₁)=E₂′×(d₂−Δd₁)=E₂′×(d₁−t−Δd₁)

E₂′=E₁′×(d₁−Δd₁)/(d₁−t−Δd₁)

E₂′>E₁′

The intensity of the electrical field can be increased with adjusting the gap between the inducing element and the counter electrode when applied the external force. That is, the influence of the counter electrode on the current of the inducing element or the inducing signal would become great, and the inducing element is more sensitive to a touch input or applied external force.

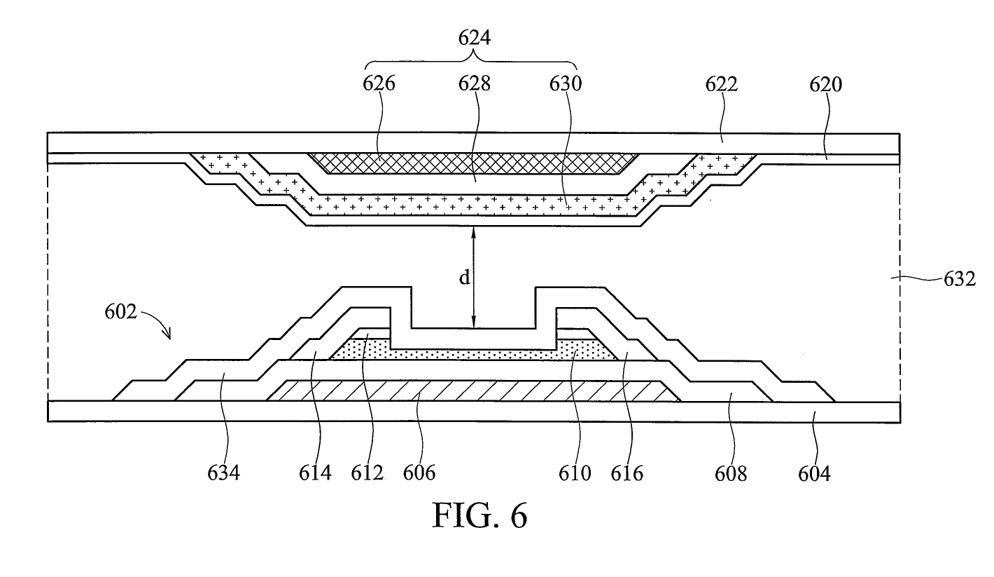

A touch input display device of an embodiment according to the invention is illustrated in accordance with FIG. 6. An inducing element 602 is disposed on a substrate 604, comprising a gate 606, a gate dielectric layer 608, a source electrode 614, a drain electrode 616, an active layer 610, a high doped layer 612 and a passivation layer 634. The active layer 610 includes a channel. The counter substrate 622 is opposite the substrate 604 with a liquid crystal layer 632 injected therebetween. A protrusion element 624 corresponding to the inducing element 602 is disposed on the counter substrate 622 for the counter electrode 620 disposed on the protrusion element 624 to be closer to the inducing element 602 thereunder, and the gap between the inducing element 602 and the counter electrode 620 is therefore reduced. For example, the gap can be reduced to be equal to or less than 2 μm or further equal to or less than 1 μm. In the embodiment, the protrusion element 624 is a stack of color resist layers, for example, comprising a first color resist layer 626, a second color resist layer 628 and a third color resist layer 630. The stack color resist layers can be used for light shielding or light filtering, and black matrix (BM) can therefore be omitted. In order to provide the light shielding or light filtering function, the stack color resist layers preferably include two or all of three major colors (R, G, B). For example, the first color resist layer 626 is red, the second color resist layer 628 is green and the third color resist layer 630 is blue.

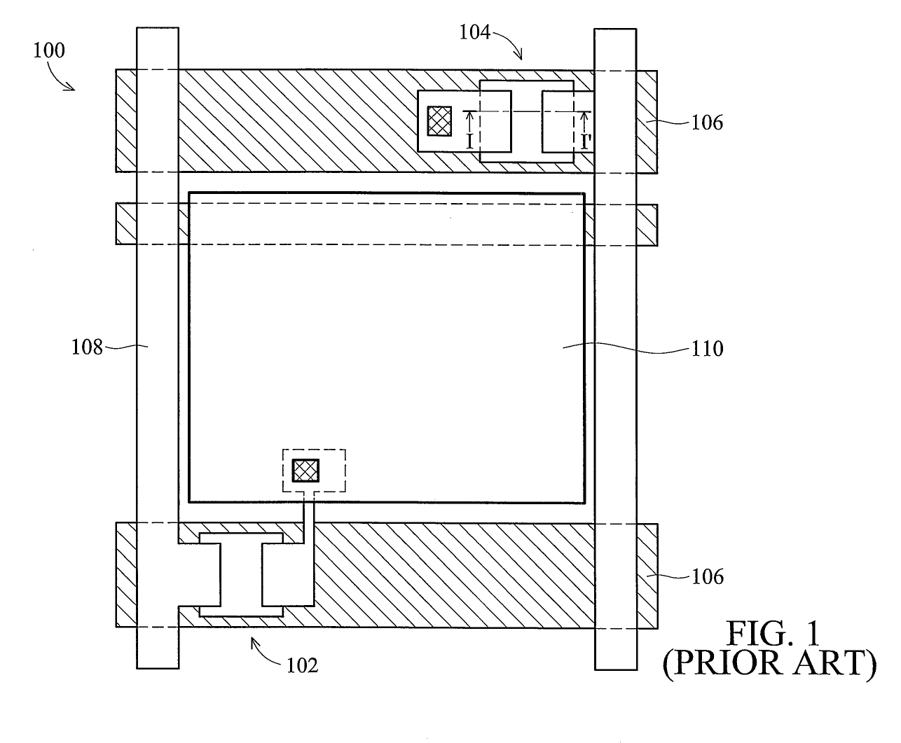

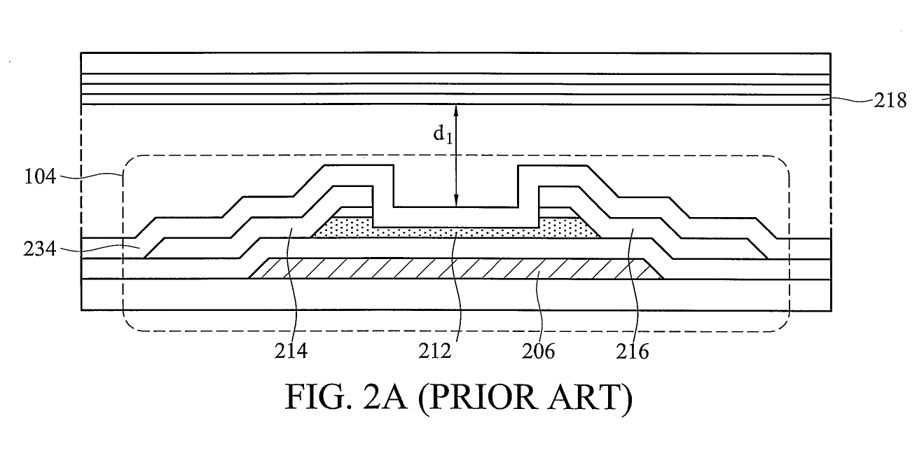

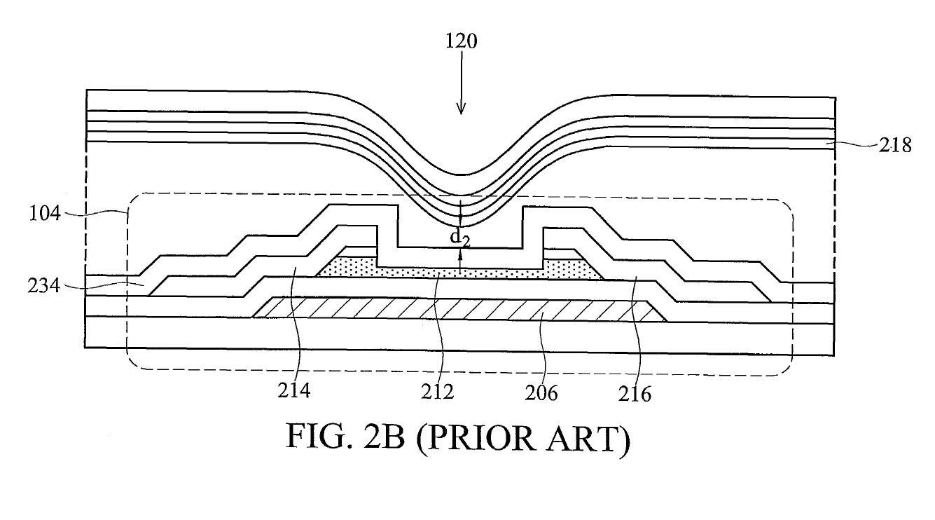

The protrusion element 624 preferably covers the active layer 610 of the inducing element 602 for the touch input display device has better performance. In the embodiment, the counter electrode 620 can also be a common electrode, which is formed of transparent conductive material, such as indium tin oxide (ITO). The pixel layout of the touch input display device of the embodiment is like that shown in FIG. 1 and is not illustrated in detailed herein for simplify. The pixel layout of the touch input display device and the position and connection of the inducing element therein can be referred to FIG. 1 and it's related description. It is noted that the inducing element is isolated (or disconnected) from the pixel electrode in the embodiment.

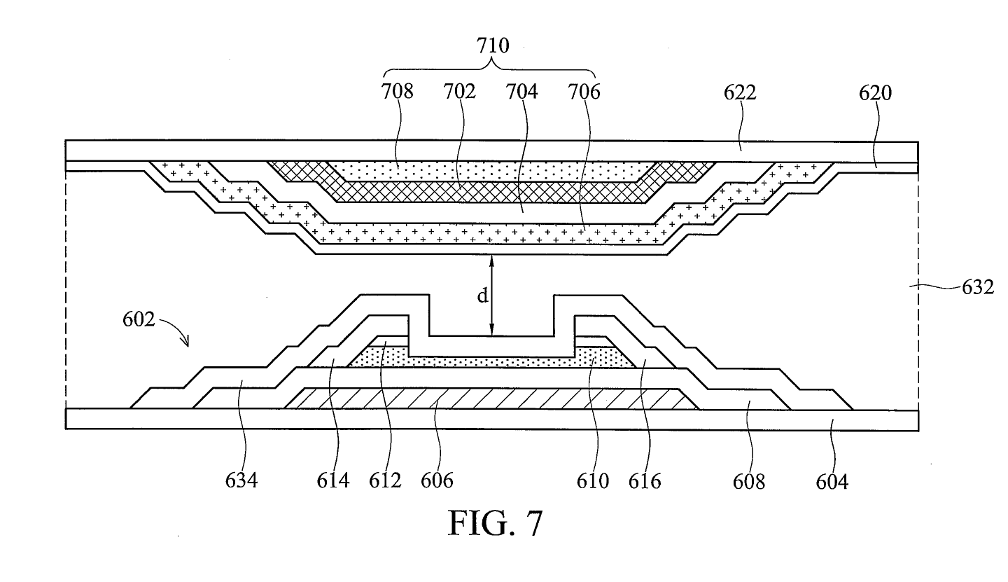

A touch input display device of another embodiment according to the invention is illustrated in accordance with FIG. 7. The touch input display device of the embodiment differs from that shown in FIG. 6 only by the protrusion element 710 and only the difference is illustrated herein, in which like elements use the same symbols. As shown in FIG. 7, in addition to the first color resist layer 702, the second color resist layer 704 and the third color resist layer 706, the protrusion element 710 further comprises a light shielding layer 708 interposed between the stacked color resist layer and the counter substrate 622. The light shielding layer 708 can be formed of metal or high polymer material. Not only for providing light shielding, the light shielding layer 708 also raises the counter electrode 620. The light shielding layer 708 itself can shield light and the color resist layers of the embodiment are not limited to that shown in FIG. 6 in order to provide shielding. For example, the color resist layers of the embodiment can be any one of the three major colors (R, G, B) or a stacked layer with two of major colors.

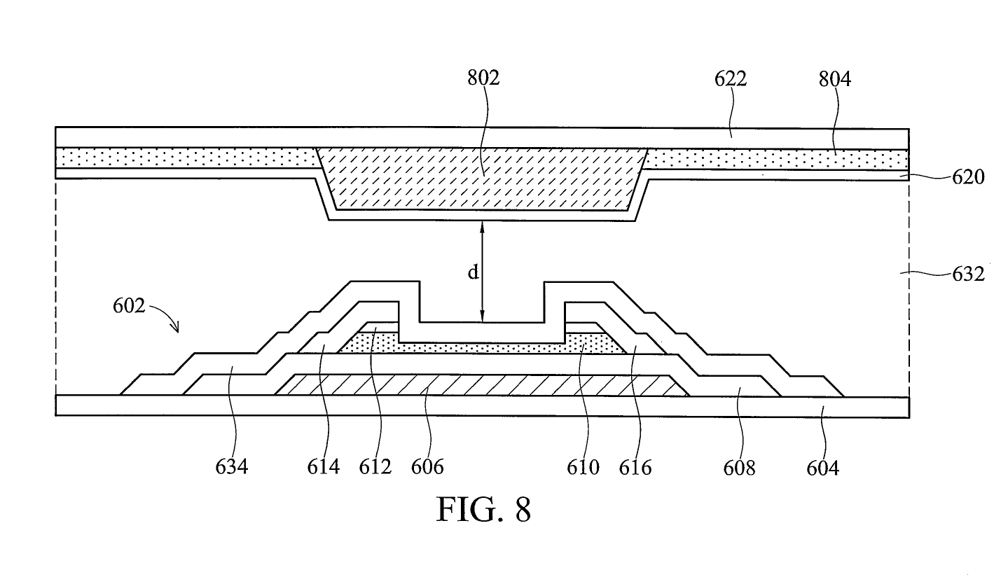

A touch input display device of further another embodiment according to the invention is illustrated in accordance with FIG. 8. The touch input display device of the embodiment differs from that shown in FIG. 6 only by arrangement of a protrusion element 802 and a light shielding layer 804, and only the difference is illustrated herein, in which like elements use the same symbols. The protrusion element 802 of the embodiment does not comprise a light shielding layer 804, but the light shielding layer 804 is disposed out of the protrusion element 802. The protrusion element 802 can be formed of transparent material, such as photo spacer, so as to make the inducing element 602 to generate signals by light irradiating, such as light pen or environment light. The inducing element 602 of the embodiment work therefore with two input mode, which one is touch input mode and another is light inducing mode. According to the touch input display devices described, because the counter electrode is raised by inserting the protrusion element to reduce the gap between the counter electrode and the inducing element, the inducing element can be affected more greatly by the variation of the electric field due to the counter substrate deformation, thus increasing sensitivity.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display device, comprising:
a substrate, comprising a pixel electrode and a first conductive line;
a counter substrate facing the substrate;
an inducing element comprising a passivation layer, disposed on the substrate, electrically connected to the first conductive line and disconnected to the pixel electrode; and
a counter electrode corresponding to the inducing element, interposed between the substrate and the counter substrate,
wherein a variable gap d is between the passivation layer and the counter electrode, and d≦1 μm.

2. The display device as claimed in claim 1, further comprising a protrusion element interposed between the counter electrode and the counter substrate.

3. The display device as claimed in claim 2, wherein the protrusion element comprises a filtering material.

4. The display device as claimed in claim 3, wherein the filtering material is a color resist layer.

5. The display device as claimed in claim 2, wherein the protrusion element comprises a light shielding material.

6. The display device as claimed in claim 5, wherein the light shielding material is a metal layer.

7. The display device as claimed in claim 2, wherein the protrusion element comprises a transparent material.

8. The display device as claimed in claim 1, wherein the first conductive layer is a gate line.

9. The display device as claimed in claim 1, further comprising a second conductive line intercrossed the first conductive line.

10. The display device as claimed in claim 9, wherein the second conductive line is a data line.

11. The display device as claimed in claim 10, further comprising a switch device electrically connected to the first conductive line, the data line and the pixel electrode.

12. A display device, comprising:
a substrate and a counter substrate opposite the substrate, wherein the substrate comprises a pixel electrode and a first conductive line;
an inducing element comprising a passivation layer, electrically connected to the first conductive line and disconnected to the pixel electrode;
a counter electrode corresponding the inducing element; and
a protrusion element interposed between the counter electrode and the counter substrate.

13. The display device as claimed in claim 12, wherein the protrusion element comprises a filtering material.

14. The display device as claimed in claim 13, wherein the filtering material is a color resist layer.

15. The display device as claimed in claim 12, wherein the protrusion element comprises a light shielding material.

16. The display device as claimed in claim 15, wherein the light shielding material is a metal layer.

17. The display device as claimed in claim 12, wherein the protrusion element comprises a transparent material.

18. The display device as claimed in claim 12, further comprising a switch device electrically connected to the first conductive line and the pixel electrode.

19. The method for forming a display device as claimed in claim 12, wherein a variable gap d is between the passivation layer and the counter electrode, and d≦2 μm.
